(19) United States
(12) Patent Application Publication
(10) Pub. No.: US 2026/0016967 A1
(43) Pub. Date: Jan. 15, 2026

(54) MEMORY SUB-SYSTEM FOR PERFORMING BLOCK STRIPE MANAGEMENT USING DEADLINE-BASED FOLDING

(71) Applicant: Micron Technology, Inc., Boise, ID (US)

(72) Inventors: Noorshaheen Mavungal Noorudheen, Longmont, CO (US); Byron D. Harris, Mead, CO (US)

(21) Appl. No.: 19/241,233

(22) Filed: Jun. 17, 2025

Related U.S. Application Data
(60) Provisional application No. 63/668,840, filed on Jul. 9, 2024.

(51) Int. Cl. G06F 3/06

(52) U.S. Cl. CPC G06F 3/0616; G06F 3/064; G06F 3/0679

(57) ABSTRACT

Various aspects of the present disclosure relate to a process for block stripe management using deadline-based folding. A processing device may determine a physical valid translation unit count of an immediate folding queue that includes a plurality of block stripes. The processing device may identify, based on the physical valid translation unit count of the immediate folding queue, a pacing value for performing the immediate folding. The processing device may determine, at a time that is based on the pacing value, whether a priority-based folding operation is being performed for the plurality of block stripes. The processing device may initiate a deadline-based folding operation for the plurality of block stripes responsive to determining that the priority-based folding operation is not being performed for the plurality of block stripes.

### RELATED APPLICATIONS

This application claims the benefit of U.S. Provisional Patent Application No. 63/668,840, filed Jul. 9, 2024, the entire contents of which are hereby incorporated by reference herein.

### TECHNICAL FIELD

Aspects of the disclosure relate generally to memory sub-systems, and more specifically, to memory sub-systems for performing block stripe management using deadline-based folding.

### BACKGROUND

A memory sub-system can include one or more memory devices that store data. The memory devices can be, for example, non-volatile memory devices and volatile memory devices. A host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various aspects of the disclosure.

FIG. 1 illustrates an example computing system that includes a memory sub-system, in accordance with some aspects of the present disclosure.

FIG. 2 is a sequence diagram of an example method of performing block stripe management using rate control, in accordance with some aspects of the present disclosure.

FIGS. 3A-3B are sequence diagrams of an example method of performing block stripe management using rate control, in accordance with some aspects of the present disclosure.

FIG. 4 is a sequence diagram of an example method of performing block stripe management using deadline-based folding, in accordance with some aspects of the present disclosure.

FIGS. 5A-5B are sequence diagrams of an example method of performing block stripe management using deadline-based folding, in accordance with some aspects of the present disclosure.

FIG. 6 is a flow diagram of an example method of performing block stripe management using rate control, in accordance with some aspects of the present disclosure.

FIG. 7 is a flow diagram of an example method of performing block stripe management using deadline-based folding, in accordance with some aspects of the present disclosure.

FIG. 8 is a block diagram of an example computer system in which some aspects of the present disclosure may operate.

### DETAILED DESCRIPTION

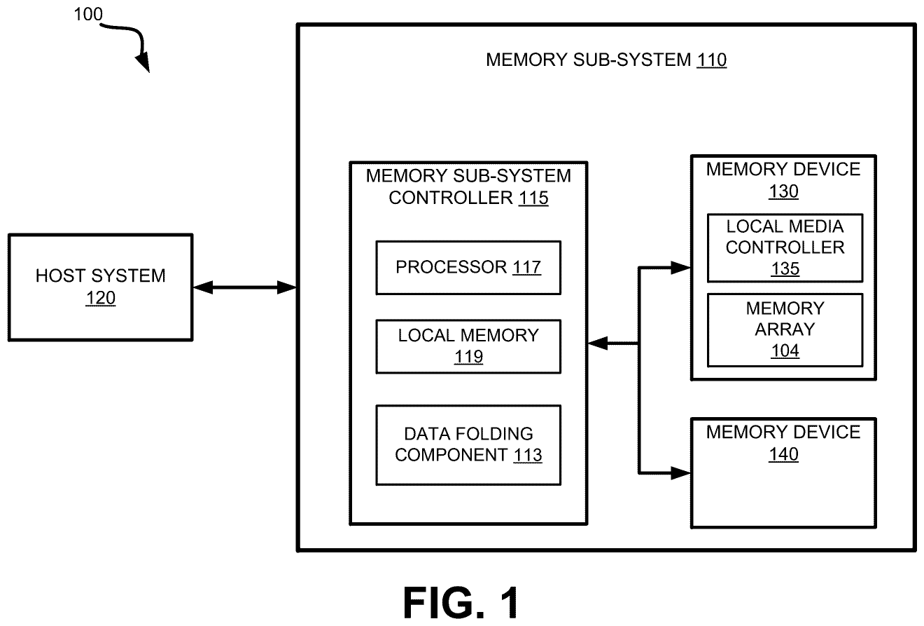

Aspects of the present disclosure are directed to a memory sub-system for is a flow diagram of an example method of performing block stripe management using deadline-based folding. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a not-and (NAND) memory device. Other examples of non-volatile memory devices are described below in conjunction with FIG. 1. A non-volatile memory device is a package of one or more dies. Each die can include one or more planes. For some types of non-volatile memory devices (e.g., NAND devices), each plane includes a set of physical blocks. Each block includes a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can include multiple memory cells arranged in a two-dimensional or a three-dimensional grid. Memory cells are formed onto a silicon wafer in a rectangular array; the memory cells may be joined by conductive lines referred to as wordlines and bitlines. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane. The memory device can include circuitry that performs concurrent memory page accesses of two or more memory planes. For example, the memory device can include multiple access line driver circuits and power circuits that can be shared by the planes of the memory device to facilitate concurrent access of pages of two or more memory planes, including different page types. For ease of description, these circuits can be generally referred to as independent plane driver circuits. Depending on the storage architecture employed, data can be stored across the memory planes (i.e., in stripes). Accordingly, one request to read a segment of data (e.g., corresponding to one or more data addresses), can result in read operations performed on two or more of the memory planes of the memory device.

A memory sub-system may include one or more memory devices. Each memory device in the memory sub-system may include one or more dies. In some aspects, the memory sub-system may include one or more memory devices, where each memory device corresponds to a single die in the memory sub-system. In some other aspects, one or more memory devices in the memory sub-system may include multiple dies of the memory sub-system. Data can be stored in a memory device using block stripes, where each block stripe spans multiple dies (for example, all dies) of the memory device and includes multiple data blocks. Each block stripe may be associated with a certain type of memory in the memory device. For example, a first quantity (or a first percent) of the block stripes may be designated as single-level cell (SLC) memory block stripes and a second quantity (or a second percent) of the block stripes may be designated as quad-level cell (QLC) memory block stripes. In some cases, a block stripe may include one or more bad blocks. A bad block is a block that is associated with an error condition. For example, a bad block may result from a manufacturing defect or physical damage to the memory device. The memory device may be able to be used even if the memory device includes a certain number of bad blocks. However, an increase in the number of bad blocks may result in an increased likelihood that the memory device will fail or need to be discarded.

Data folding is a memory optimization technique that includes moving valid data from one memory portion of a memory device to another memory portion of the memory device. In some examples, a data folding operation may be associated with a garbage collection operation that can be used for increasing an amount available space in the memory device. Garbage collection is a process of reclaiming unused or invalid data blocks to free up space and optimize memory utilization. A garbage collection process can include identifying valid data in one or more block stripes, moving the valid data to one or more other block stripes, and erasing the block stripes that no longer contain any valid data. By consolidating free space and reducing fragmentation, garbage collection can help maintain efficient storage performance. In some other examples, the data folding operation may be associated with a static wear leveling operation. Static wear leveling is a technique used in memory devices to distribute write and erase cycles evenly across all memory cells of the memory device. Wear leveling algorithms can be used to periodically move data from frequently used cells to less frequently used cells, or to direct new write operations towards the less frequently used cells, thereby improving a likelihood of balanced usage of all available memory cells. This even distribution of wear can improve the reliability and performance of the memory device as each cell has a limited number of program/erase cycles (PEC). Additionally, the even distribution of wear can prevent certain cells from wearing out prematurely due to frequent use, thereby extending the overall lifespan of the memory device.

Data folding can be performed within a cache of the memory device, within a data band of the memory device, or between the cache of the memory device and the data band of the memory device. The data band of the memory device can include at least one of the SLC memory or the QLC memory described above. Cache-to-cache (C2C) folding includes folding data from one or more cache block stripes of the memory device to one or more other cache block stripes of the memory device. This can be used to keep frequently accessed data within the higher levels of the cache hierarchy (such as within Layer 1 (L1) and Layer 2 (L2) of the cache), thereby minimizing the need for slower data band memory accesses. Data-to-data (D2D) folding includes folding data from one or more data band block stripes of the memory device to one or more other data band block stripes of the memory device. This can be used to arrange the data in a way that accesses to related data items result in fewer cache line replacements and better cache utilization. Cache-to-data (C2D) folding includes folding data from one or more cache block stripes of the memory device to one or more data band block stripes of the memory device. Moving data from the cache to the data band may be performed to consolidate data in a more compact form, such as to move data from memory storing one bit per cell to memory storing multiple bits per cell, thereby improving a capacity of the memory device.

Write amplification occurs when an actual amount of physical data written to the memory cells of the memory device is greater than an amount of logical data that is written to the memory device by the host. In some examples, the memory device may require that entire blocks (or block stripes) of the memory device be erased and rewritten even if only a small amount of data in the block (or block stripe) is changed. This can result in additional write operations being performed, thereby amplifying the amount of data that is written to the memory cells of the memory device. Garbage collection and wear leveling, as described above, are important memory device functions that improve the functionality of the memory device but that can result in increased write amplification on the memory device. Increased write amplification can lead to reduced performance of the memory device as the additional write operations can increase latency and decrease throughput, for example, due to the larger number of write operations being performed. Additionally, increased write amplification can shorten the lifespan of the memory device as the memory cells may have a limited number of program/erase cycles. In some cases, the processing device may perform data folding based on a deadline value. For example, the processing device may identify a plurality of deadline values for a plurality of respective data folding operations, where each folding operation is associated with a corresponding block stripe on the memory device. The processing device may perform data folding for the block stripes based on the corresponding deadline values. For example, the processing device may perform a data folding operation for one or more block stripes each time that a deadline for is detected. This may result in frequent write operations to the memory device, thereby increasing write amplification on the memory device. In contrast, reducing the frequency of the data folding operations may increase a likelihood of a missing a folding deadline, which can be detrimental to the performance of the memory device. The processing device may not be configured with information that enables the processing device to balance data folding deadlines against increased write amplification on the memory device. Additionally, the processing device may not be configured with information that enables the processing device to determine whether to prioritize certain types of folding operations over others, such as whether to prioritize D2D folding over C2D folding, when the processing device has a large number of folding operations to be performed.

Aspects of the present disclosure address the above and other deficiencies by implementing a memory sub-system for performing block stripe management using rate control. A processing device may determine to perform immediate folding for a block stripe of the memory device based on an immediate folding criteria. The immediate folding criteria may correspond to a reason for performing the immediate folding operation, such as an occurrence of a programming fail, a logical unit number fail, a read disturb scan, a background scan, a retention scan, a secure erase, or a detection of an uncorrectable read error. The processing device may identify a deadline value, a priority value, and/or a resource value that corresponds to the immediate folding criteria, where the deadline value indicates a maximum time period for completing the immediate folding, the priority value indicates a priority for the immediate folding for the block stripe, and the resource value indicates at least one of quantity of processing resources or a percentage of processing resources to be used for performing the immediate folding. The processing device may add the block stripe to an immediate fold queue based on a combination of the deadline value and the time value, such as based on a sum of the deadline value and the time value, and may determine a rate control value based on a combination of the priority value and the resource value. The rate control value may indicate a rate at which the processing device is to perform immediate folding for the block stripes in the block stripe queue. In some aspects, the rate control value may indicate whether to prioritize one type of folding operation over another type of folding operation, such as whether to prioritize D2D folding over C2D folding. The processing device may perform immediate folding for the block stripes in the immediate folding queue using the rate control value.

Some advantages of the present disclosure include enabling the processing device to satisfy data folding deadlines while balancing available space on the memory device, thereby improving the overall performance and reliability of the memory device while reducing write amplification. Some advantages of the present disclosure include enabling the processing device to prioritize which block stripes are to be folded based on priorities and folding deadlines. Some advantages of the present disclosure include enabling the processing device to prioritize certain types of folding operations over other types of folding operations. For example, the processing device may be enabled to prioritize D2D folding over C2D folding based on the priorities and folding deadlines. Some advantages of the present disclosure include reducing a number of write operations on the memory device. This may result in reduced write amplification and power consumption, thereby increasing the lifespan of the memory device. These example advantages, among others, are described in more detail herein.

As described above, data folding can occur during garbage collection or static wear leveling operations. Additionally, or alternatively, data folding can be performed to avoid missing a data folding deadline. A processing device may access a data folding queue that includes multiple deadline values, where each deadline value of the multiple deadline values indicates a deadline (a data folding deadline) at which a data folding operation to be completed. The processing device may perform a data folding operation for a block stripe in the data folding queue based on a corresponding deadline value for the block stripe being within a specified time window of a current time value of the memory device. For example, the processing device may initiate a data folding operation for the block stripe based on the corresponding deadline value for the block stripe being within one hour of the current time value. In some examples, the data folding queue may include a large number of deadline values that are close together in time but that are not close to the specified time window of the current time value. For example, the data folding queue may not include any deadline values (or may include a small number of deadline values) that are within a next forty-eight hours of the current time value, but may include a large number of deadline values that are within a two-hour time window starting forty-eight hours after the current time value. Since there are few or zero deadline values within the next forty-eight hours of the current time value, the processing device may not perform any data folding operations. For example, the processing device may not perform any data folding operations for the next forty-seven hours. However, this may result in the processing device needing to perform a large number of folding operations within the two-hour time window starting at forty-eight hours after the current time value. This may result in the processing resources of the memory system being overwhelmed by data folding operations within the two-hour time window. Additionally, or alternatively, this may result in one or more of the data folding deadlines being missed, which can be detrimental to the performance of the memory device.

In addition, aspects of the present disclosure provide a memory sub-system for performing block stripe management using deadline-based folding. A processing device may determine a physical valid translation unit count (PVTC) of an immediate folding queue. The physical valid translation unit count of the immediate folding queue may indicate a total quantity of physical valid translation units of all block stripes included in the immediate folding queue. The processing device may identify a pacing value for performing immediate folding for the block stripes in the immediate folding queue based on the physical valid translation unit count of the immediate folding queue. For example, the processing device may select a first pacing value for performing the immediate folding based on the physical valid translation unit count of the immediate folding queue having a first value, or may select a second pacing value for performing the immediate folding based on the physical valid translation unit count of the immediate folding queue having a second value, where the pacing value corresponds to a time interval at which the processing device is to determine whether a priority-based folding operation is being performed. The processing device may determine, at a time that is based on the pacing value, whether a priority-based folding operation is being performed for the plurality of block stripes. For example, if the physical valid translation unit count value is two-hundred, and the corresponding pacing value is thirty seconds, the processing device may determine, at one or more iterations of a thirty-second interval, whether a priority-based folding operation is being performed for the plurality of block stripes. The priority-based folding operation may include a folding operation associated with increasing available space on the memory device, a folding operation associated with satisfying a priority value, or a folding operation associated with performing static wear leveling, among other examples. The processing device may initiate a deadline-based folding operation for the plurality of block stripes responsive to determining that a priority-based folding operation is not being performed for the plurality of block stripes.

Some advantages of the present disclosure include enabling a processing device to perform data folding based on a physical valid translation unit count of a data folding queue. Some advantages of the present disclosure include enabling the processing device to balance priority-based folding operations and deadline-based folding operations. For example, the processing device may be enabled to perform deadline-based folding operations only when there are no priority-based folding deadlines being performed. Some advantages of the present disclosure include enabling the processing device to perform deadline-based folding periodically, regardless of whether there are folding deadlines within a current time value of the memory device. Some advantages of the present disclosure include reducing a likelihood of missed folding deadlines. Some advantages of the present disclosure include reducing a likelihood of a large number of folding operations needing to be performed at a given time. These example advantages, among others, are described in more detail herein.

FIG. 1 illustrates an example computing system 100 that includes a memory sub-system 110, in accordance with some aspects of the present disclosure. The memory sub-system 110 can include media, such as one or more volatile memory devices (e.g., memory device 140), one or more non-volatile memory devices (e.g., one or more memory device(s) 130), or a combination of such.

The memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some aspects, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access the memory components (e.g., the one or more memory device(s) 130) when the memory sub-system 110 is coupled with the host system 120 by the physical host interface (e.g., PCIe or CXL interface). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be random access memory (RAM), such as dynamic random access memory (DRAM) and synchronous dynamic random access memory (SDRAM).

Some examples of non-volatile memory devices (e.g., memory device(s) 130) include negative-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory device(s) 130 can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some aspects, each of the memory devices 130 can include one or more arrays of memory cells such as SLCs, MLCs, TLCs, QLCs, or any combination of such. In some aspects, a particular memory device can include an SLC portion, and at least one of an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, electrically erasable programmable read-only memory (EEPROM).

A memory sub-system controller 115 (or controller 115 for simplicity) can communicate with the memory device(s) 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some aspects, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in some other aspects, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device(s) 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory device(s) 130. The memory sub-system controller 115 can further include host interface circuitry to communicate with the host system 120 via the physical host interface. The host interface circuitry can convert the commands received from the host system into command instructions to access the memory device(s) 130 as well as convert responses associated with the memory device(s) 130 into information for the host system 120.

The memory sub-system 110 can also include additional circuitry or components that are not illustrated. In some aspects, the memory sub-system 110 can include a cache or buffer (e.g., DRAM) and address circuitry (e.g., a row decoder and a column decoder) that can receive an address from the memory sub-system controller 115 and decode the address to access the memory device(s) 130.

In some aspects, the memory device(s) 130 include local media controllers 135 that operate in conjunction with memory sub-system controller 115 to execute operations on one or more memory cells of the memory device(s) 130. An external controller (e.g., memory sub-system controller 115) can externally manage the memory device 130 (e.g., perform media management operations on the memory device(s) 130). In some aspects, a memory device 130 is a managed memory device, which is a raw memory device (e.g., memory array 104) having control logic (e.g., local controller 135) for media management within the same memory device package. An example of a managed memory device is a managed NAND (MNAND) device. Memory device(s) 130, for example, can each represent a single die having some control logic (e.g., local media controller 135) embodied thereon. In some aspects, one or more components of memory sub-system 110 can be omitted.

In some aspects, the memory sub-system 110 includes a data folding component 113. The data folding component 113 can be configured to perform data folding for one or more block stripes of the memory device 130 based on one or more conditions. In some aspects, the data folding component 113 can perform data folding for the one or more block stripes using a rate control value. For example, the data folding component 113 can obtain or determine an immediate folding criteria, which may correspond to a reason for performing the data folding operation, and may obtain or determine a deadline value, a priority value, and a resource value corresponding to the immediate folding criteria. Additionally, the data folding component 113 can obtain or determine a rate control value for performing immediate folding for a set of block stripes in the immediate folding queue, where the rate control value is based on the deadline value and a current time value of the memory device, and may perform immediate folding for the one or more block stripes in the immediate folding queue using the rate control value. In some other aspects, the data folding component 113 can perform data folding for the one or more block stripes using a pacing value. For example, the data folding component 113 can obtain or determine a pacing value for performing immediate folding, where the pacing value is based on a physical valid translation unit count of the immediate folding queue. Additionally, the data folding component 113 can determine, at a time that is based on the pacing value, whether a priority-based folding operation is being performed for the plurality of block stripes, and can initiate a deadline-based folding operation based on determining that the priority-based folding operation is not being performed for the plurality of block stripes. Additional details regarding these features are described below.

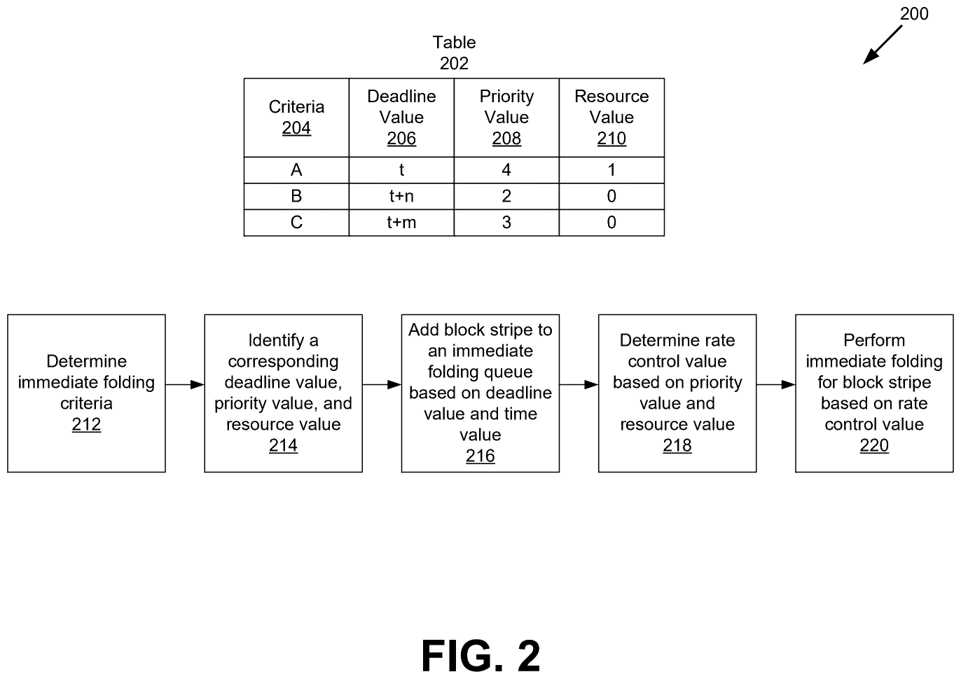

FIG. 2 is a sequence diagram of an example method 200 of performing block stripe management using rate control, in accordance with some aspects of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some aspects, one or more operations of the method 200 are performed by the data folding component 113 of FIG. 1. Although shown in a particular sequence or order, unless otherwise specified, the order of the processes can be modified. Thus, the illustrated aspects should be understood only as examples, and the illustrated processes can be performed in a different order, and some processes can be performed in parallel. Additionally, one or more processes can be omitted in various aspects. Thus, not all processes are required in every aspect. Other process flows are possible.

In some aspects, the processing logic (for example, the data folding component 113) may access a table 202. The table 202 may include one or more criteria 204 for performing data folding operations. A criteria 204 for performing a data folding operation may correspond to a reason for performing the data folding operation. In some examples, the criteria 204 may include at least a first criteria (criteria A), a second criteria (criteria B), and a third criteria (criteria C). For example, the criteria 204 may include a programming fail criteria, a logical unit number (LUN) fail criteria, a read disturb scan criteria, a background scan criteria, a retention scan criteria, a secure erase criteria, and/or an uncorrectable read error, among other examples. For each criteria 204, the table 202 may include a deadline value 206, a priority value 208, and a resource value 210. The deadline value 206 may indicate a time duration that is allocated for a folding operation having the criteria to be performed. For example, the deadline value may indicate a maximum number of seconds allocated for the folding operation having the criteria to be performed. As shown in table 202, Criteria A may have a deadline value of t (for example, one thousand seconds), Criteria B may have a deadline value of t+n (for example, three thousand seconds), and Criteria C may have a deadline value of t+m (for example, ten thousand seconds). The priority value 208 may indicate a priority for the data folding operation having the criteria. The priority value 208 may be a value that is included in a range of values, such as a value that is included within the rage of integers from zero through four, where zero indicates a lowest priority for the folding operation and four indicates a highest priority for the folding operation. As shown in table 202, Criteria A may have a priority value of four, Criteria B may have a priority value of two, and Criteria C may have a priority value of three. The resource value 210 may indicate a quantity of processing resources that are to be allocated for performing the data folding operation. In some aspects, a percentage of the processing resources associated with the processing logic may be allocated as data folding processing resources. For example, thirty percent of the processing resources associated with the processing logic may be allocated as data folding processing resources. Therefore, the resource value 210 may indicate a quantity of the data folding processing resources that are to be used for performing the data folding operation for a corresponding criteria. In one example, a first value (“0”) for the resource value 210 may indicate that the processing logic can allocate a portion of the data folding processing resources for performing the data folding operation and may allocate another portion of the data folding processing resources for performing other processing operations, whereas a second value (“1”) for the resource value 210 may indicate that all data folding processing resources are to be allocated for performing the data folding operation. As shown in table 202, Criteria A may have a resource value of 1, Criteria B may have a resource value of 0, and Criteria C may have a resource value of 0.

At operation 212, the processing logic determines an immediate folding criteria for a data folding operation. As described herein, the immediate folding criteria may correspond to a reason that the immediate folding operation is being performed. In some aspects, the processing logic may access a written queue that includes a plurality of block stripes and, for each block stripe of the plurality of block stripes, indicates a block stripe identifier (BSID), a version number, and a physical valid translation unit count. The processing logic may identify one or more block stripes from the written queue for which immediate folding is to be performed. For example, the processing logic may identify one or more block stripes from the written queue that are associated with a programming fail, a LUN fail, a read disturb scan, a background scan, a retention scan, a secure erase, or an uncorrectable read error. In some examples, the one or more block stripes having the one or more criteria may correspond to the block stripes in the written queue having the lowest physical valid translation unit count.

At operation 214, the processing logic identifies a deadline value, a priority value, and/or a resource value corresponding to the criteria. For example, based on the processing logic determining that the immediate folding criteria for an immediate folding operation is Criteria B, the processing logic may identify a corresponding deadline value of t+n, a priority value of two, and a resource value of zero.

At operation 216, the processing logic adds the block stripe to an immediate folding queue based on a combination of the deadline value and a current time value. For example, the processing logic may add the block stripe to the immediate folding queue based on a sum of the deadline value and a current time value of the memory device. As described herein, the immediate folding queue may include a plurality of block stripes and may indicate, for each block stripe of the plurality of block stripes, a block stripe identifier, a deadline, and a priority. The processing logic may calculate the sum of the deadline value for the immediate folding operation and the current time value of the memory device, and may add the block stripe to the immediate folding queue based on a result of the calculation.

In one example, the current time value of the memory device may be twenty thousand seconds. A deadline for the immediate folding operation to be completed may be equal to the sum of the deadline value for the criteria (three thousand seconds) and the current time value. Therefore, the deadline for the immediate folding operation is twenty three thousand seconds. In this example, the immediate folding queue may include three existing entries, a first existing entry having a deadline of eighteen thousand seconds, a second existing entry having a deadline of twenty five thousand seconds, and a third existing entry having a deadline of forty thousand seconds. Therefore, the processing logic may add the block stripe to the immediate folding queue after the first existing entry but before the second existing entry.

At operation 218, the processing logic determines a rate control value based on a system priority value and a system resource value. The rate control value may indicate a rate at which the immediate folding operations for the block stripes in the immediate folding queue are to be performed. For example, a rate control value of three may indicate that three folding operations are to be performed per second, whereas a rate control value of ten may indicate that ten folding operations are to be performed per second. The system priority value may indicate the highest priority value for any block stripe in the immediate folding queue. For example, if the immediate folding queue includes four entries having priority values of three, two, one, and four, respectively, the system priority value may be four. In another example, if the immediate folding queue includes four entries having priority values of one, two, three, and one, respectively, the system priority value may be three. The system resource value may indicate the highest resource value for any block stripe in the immediate folding queue. For example, if the immediate folding queue includes four entries having priority values of one, zero, zero, and one, respectively, the system priority value may be one. In another example, if the immediate folding queue includes four entries having priority values of zero, zero, zero, and zero, respectively, the system priority value may be zero.

In some aspects, the processing logic may access a look-up table that includes a plurality of immediate folding ratio impact values. Each immediate folding ratio impact value of the plurality of immediate folding ratio impact values may correspond to a combination of a PVTC value of a plurality of PVTC values and a system priority value of a plurality of system priority values. The PVTC value may correspond to a total quantity of physical valid translation units of all block stripes in the immediate folding queue. Generally, the immediate folding ratio impact value increases with the PVTC value and the system priority value. For example, a system priority value of three (in a range of values from zero to four) and a PVTC value of two hundred may indicate an immediate folding ratio impact value of four (in a range of values from zero to five), whereas a system priority value of two and a PVTC value of one hundred may indicate an immediate folding ratio impact value of two.

In some aspects, the immediate folding ratio impact value and/or the rate control value may be used to determine whether a certain type of folding operation is to be prioritized over another type of folding operation. For example, the immediate folding ratio impact value and/or the rate control value may be used to determine whether D2D folding is to be prioritized over C2D folding. The rate control may favor D2D folding over C2D folding (or vice versa) based on one or more conditions (such as an amount of available space on the memory device).

In some aspects, the processing logic, to determine the rate control value based on the system priority value and the system resource value, may determine the rate control value based on the system resource value and the immediate folding ratio impact value, where the immediate folding ratio impact value is based on a combination of the system priority value and the physical valid translation unit count value.

In some aspects, the processing logic, to determine the rate control value, may send one or more parameters to a rate control component of system 100, and may receive a rate control value from the rate control function that is based on the one or more parameters. For example, the processing logic may provide the system priority value and the immediate folding ratio impact value to the rate control component. The rate control component may calculate the rate control value based on the system priority value immediate folding ratio impact value, and may provide the rate control value to the processing logic.

In some aspects, the rate control value may be determined based on one or more other parameters (in addition, or alternatively, to the system priority value and the immediate folding ratio impact value). For example, the rate control value may be calculated (by the processing logic or the rate control component) based on an average PVTC value of a next N block stripes in the data band. In some examples, N may be a constant number of block stripes. In some other examples, N may be adjusted based on one or more conditions. For example, N may be higher for a static wear leveling data folding operation and may be lower for a garbage collection data folding operation. Additionally, or alternatively, the rate control value may be calculated (by the processing logic or the rate control component) based on a potential number of available block stripes (in the cache and the data band). For example, the rate control value may be calculated based on a combination (such as a sum) of all block stripes in a garbage collection pool, a logical-to-physical bulk update pool, an immediate erase pool, a folding purgatory pool, an erasing pool, and/or a free pool.

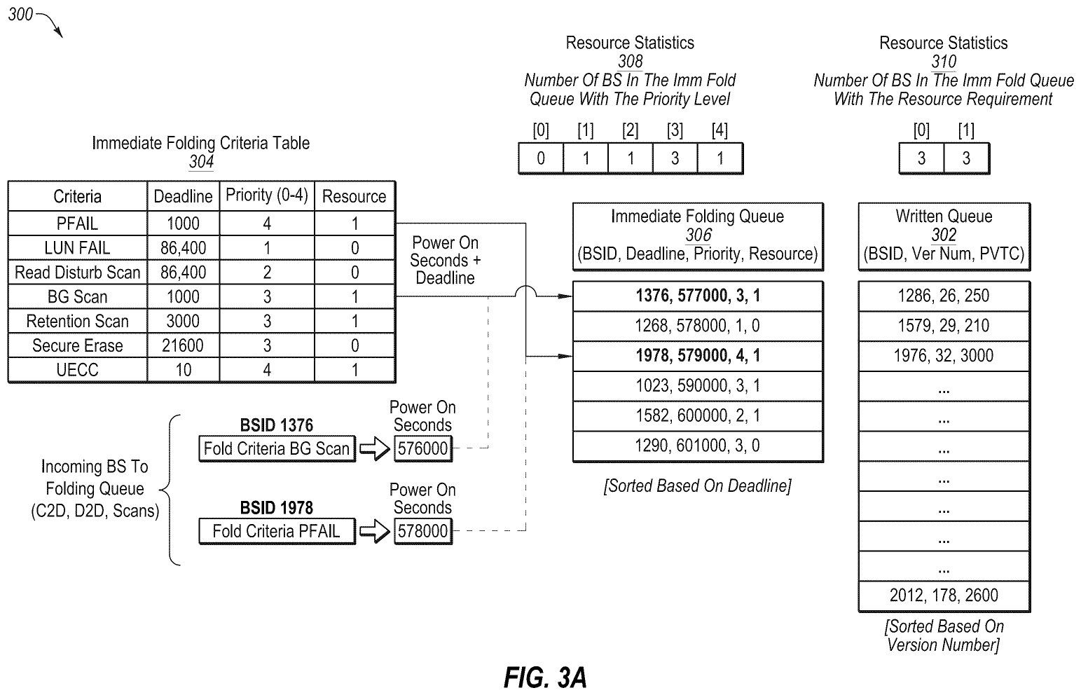

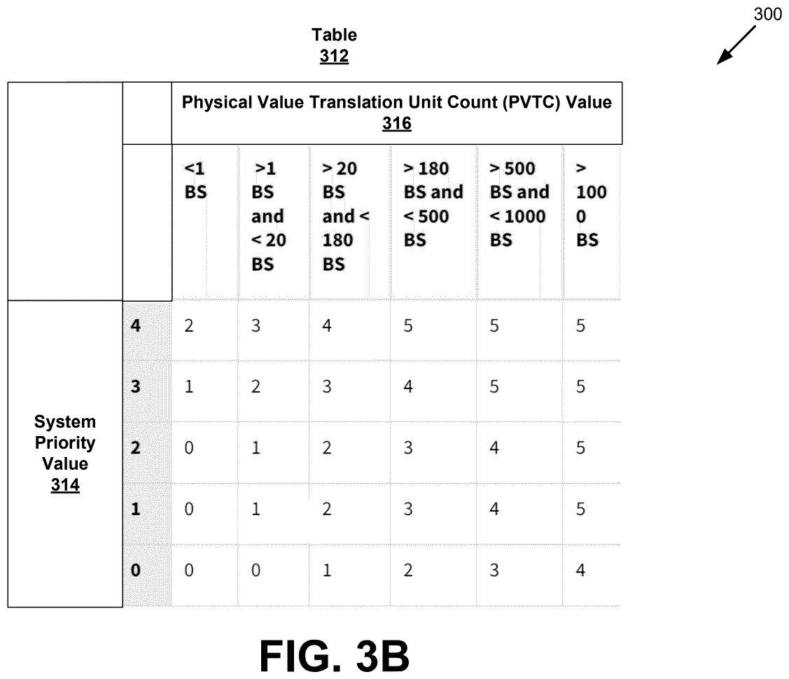

FIGS. 3A-3B are sequence diagrams of an example method 300 of performing block stripe management using rate control, in accordance with some aspects of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some aspects, one or more operations of the method 300 are performed by the data folding component 113 of FIG. 1. Although shown in a particular sequence or order, unless otherwise specified, the order of the processes can be modified. Thus, the illustrated aspects should be understood only as examples, and the illustrated processes can be performed in a different order, and some processes can be performed in parallel. Additionally, one or more processes can be omitted in various aspects. Thus, not all processes are required in every aspect. Other process flows are possible.

As shown in FIG. 3A, a written queue 302 may include a plurality of block stripes that are written to a memory of the memory device. The written queue 302 may indicate, for each block stripe included in the written queue, a block stripe identifier, a version number, and a physical valid translation unit count. The written queue 302 may be sorted based on the version number. For example, the block stripes included in the written queue 302 may be sorted based on the respective version numbers of the block stripes. As described in connection with operation 212 of FIG. 2, processing logic may select one or more block stripes from the written queue 302 for performing immediate folding.

An immediate folding criteria table 304 may include a plurality of criteria for performing data folding operations for the block stripes in the written queue. For example, the immediate folding criteria table 304 may indicate a plurality of reasons for performing the data folding operations for the block stripes in the written queue 302, such as a programming fail, a LUN fail, a read disturb scan, a background scan, a retention scan, a secure erase, and an uncorrectable read error, among other examples. Additionally, the immediate folding criteria table 304 may include a plurality of parameters for each folding criteria. For example, the immediate folding criteria table 304 may indicate, for each criterion of the plurality of criteria, a deadline value, a priority value, and a resource value. As described in connection with operations 212 and 214 of FIG. 2, processing logic may determine an immediate folding criteria for a block stripe and may identify a deadline value, a priority value, and a resource value corresponding to the immediate folding criteria.

An immediate folding queue 306 may include a plurality of block stripes for which immediate folding is to be performed. The immediate folding queue 306 may include one or more parameters for the block stripes included in the immediate folding queue 306. For example, the immediate folding queue 306 may indicate, for each block stripe included in the immediate folding queue 306, a block stripe identifier, a deadline, and a priority. As described in connection with operation 216 of FIG. 2, processing logic may add one or more block stripes to the immediate folding queue 306 based on the deadline value and a time value. The time value may correspond to a timer of the memory device. For example, the time value may correspond to a power on seconds value of the memory device.

In one example, a first block stripe associated with BSID 1376 may be selected for immediate folding based on a background (BG) scan operation being performed for the first block stripe at a power on seconds value of 576000. The processing logic may determine that an immediate folding operation for a background scan has a deadline value of 1000, a priority value of three, and a resource value of one. The processing logic may calculate a deadline for the folding operation to be completed for the first block stripe based on a sum of the power on seconds value and the deadline value. Therefore, the processing logic may determine a deadline for the first block stripe to be 577000. The processing logic may add the first block stripe to the immediate folding queue 306 based on the deadline.

In another example, a second block stripe associated with BSID 1978 may be selected for immediate folding based on a programming failure associated with the second block stripe at a power on seconds value of 578000. The processing logic may determine that an immediate folding operation for a programming failure has a deadline value of 1000, a priority value of four, and a resource value of one. The processing logic may calculate a deadline for the folding operation to be completed for the second block stripe based on a sum of the power on seconds value and the deadline value. Therefore, the processing logic may determine a deadline for the second block stripe to be 579000. The processing logic may add the first block stripe to the immediate folding queue 306 based on the deadline.

In some aspects, the processing logic may maintain priority statistics 308 and resource statistics 310. The priority statistics 308 may indicate a number of block stripes having certain priority values. For example, the priority statistics 308 may include a table that indicates, for each priority value of the plurality of priority values in the immediate folding queue 306, a number of block stripes having the priority value. In the example 300, there are zero block stripes having a priority value of zero, one block stripe having a priority value of one, one block stripe having a priority value of two, three block stripes having a priority value of three, and one block stripe having a priority value of four. The resource statistics 310 may indicate a number of block stripes having certain resource values. For example, the resource statistics 310 may include a table that indicates, for each resource value of the plurality of resource values in the immediate folding queue 306, a number of block stripes having the resource value. In the example 300, there are three block stripes having a resource value of zero and three block stripes having a resource value of one.

As shown in FIG. 3B, a table 312 may include a plurality of system priority values 314 and a plurality of PVTC values 316. The plurality of system priority values 314 and the plurality of PVTC values 316 may be associated with the immediate folding queue 306. The system priority value 314 may correspond to a highest system priority from the immediate folding queue 306. Additionally, or alternatively, the system priority value 314 may correspond to the highest non-zero value in the priority statistics 308. The PVTC value 316 may correspond to the total PVTC count of all block stripes in the immediate folding queue 306. The table 312 may include, for each combination of a system priority value 314 and a PVTC value 316, an immediate folding ratio impact value. In one example, the immediate folding ratio impact value may be equal to one based on the system priority value 314 being equal to one and the PVTC value 314 being greater than one and less than 20. In another example, the immediate folding ratio impact value may be equal to four based on the system priority value 314 being equal to three and based on the PVTC value 316 being greater than one hundred eighty and less than five hundred. As described on connection with operations 218 and 220 of FIG. 2, the immediate folding ratio impact value may be used by the processing logic (and/or a rate control component of the system 100) in determining whether a certain type of folding operation is to be prioritized over another type of folding operation. For example, the immediate folding ratio impact value may be used to determine whether D2D folding is to be prioritized over C2D folding.

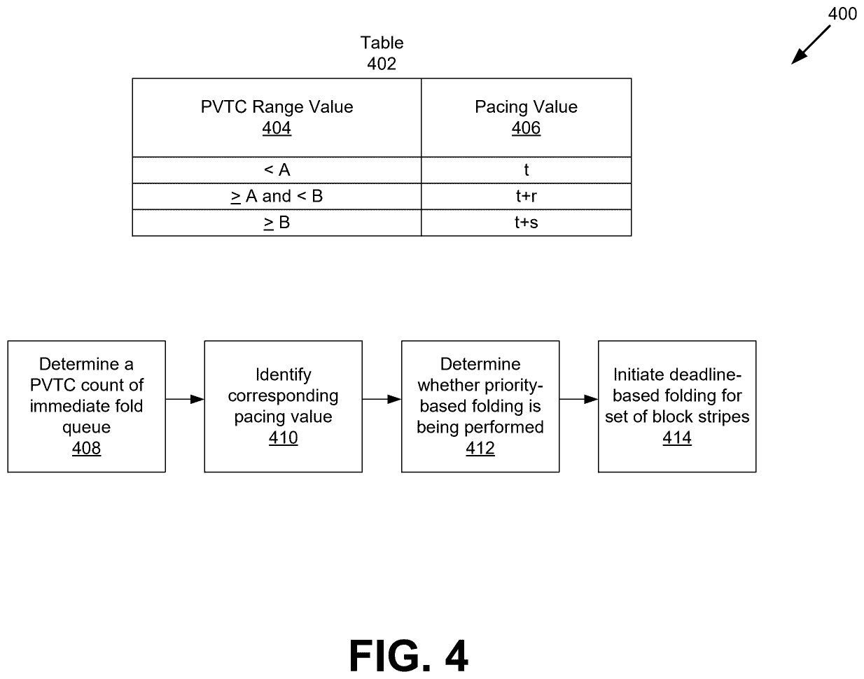

FIG. 4 is a sequence diagram of an example method 400 of performing block stripe management using deadline-based folding, in accordance with some aspects of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some aspects, one or more operations of the method 400 are performed by the data folding component 113 of FIG. 1. Although shown in a particular sequence or order, unless otherwise specified, the order of the processes can be modified. Thus, the illustrated aspects should be understood only as examples, and the illustrated processes can be performed in a different order, and some processes can be performed in parallel. Additionally, one or more processes can be omitted in various aspects. Thus, not all processes are required in every aspect. Other process flows are possible.

In some aspects, the processing logic (for example, the data folding component 113) accesses a table 402. The table 402 may include a plurality of PVTC range values 404 and a plurality of pacing values 406. A PVTC value included in the plurality of PVTC range values 404 may indicate a total quantity of physical valid translation units of all block stripes included in an immediate folding queue, such as the immediate folding queue 306 described in connection with FIG. 3A. Each pacing value of the plurality of pacing values 406 may indicate a rate at which immediate folding is to be performed for the set of block stripes. For example, each pacing value of the plurality of pacing values 406 may indicate a time interval at which the processing logic is to determine whether a priority-based folding operation is being performed for a set of block stripes included in the immediate folding queue, and to selectively initiate the immediate folding for the set of block stripes based on the determination.

At operation 408, the processing logic determines a PVTC of the immediate folding queue. For example, the processing logic may determine a total PVTC for all block stripes of the set of block stripes included in the immediate folding queue. The processing logic may determine whether the PVTC of the immediate folding queue falls within a PVTC range value of the plurality of PVTC range values 404. In one example, a first PVTC range value includes all PVTC values that less than A (for example, one hundred), a second PVTC range value includes all PVTC values that are greater than or equal to A and that are less than B (for example, five hundred), and a third PVTC range value includes all PVTC values that are greater than or equal to B. The processing logic may calculate the PVTC of the immediate folding queue and may determine whether the PVTC of the immediate folding queue falls within the first PVTC range value, the second PVTC range value, or the third PVTC range value.

At operation 410, the processing logic identifies a corresponding pacing value. In some aspects, the plurality of pacing values may include a first pacing value t (for example, one minute), a second pacing value t+r (for example, ten minutes), and third pacing value t+s (for example, one hour). The first pacing value t may correspond to the first PVTC range value, the second pacing value t+r may correspond to the second PVTC range value, and the third pacing value t+s may correspond to the third PVTC range value. In one example, the processing logic may determine that the PVTC count of the immediate folding queue is within the second PVTC range value. For example, the processing logic may determine that the PVTC of the immediate folding queue is two hundred, which is greater than or equal to A (one hundred) but less than B (five hundred). Therefore, the processing logic may determine a corresponding pacing value of t+r (ten minutes).

At operation 412, the processing logic determines whether priority-based folding is being performed. For example, the processing logic may determine whether a priority-based folding operation is being performed for the set of block stripes in the immediate folding queue. The priority-based folding operation may include a folding operation associated with increasing available space on the memory device, a folding operation associated with satisfying a priority value (such as one or more of the priority values 208 described in connection with FIG. 2), or a folding operation associated with performing static wear leveling, among other examples. The processing logic may determine whether the priority-based folding operation is being performed at a time that is in accordance with the pacing value. For example, if the PVTC of the immediate folding queue is within the second PVTC range value, the processing logic may determine, at a time interval that is based on the corresponding pacing value t+r (for example, every ten minutes), whether the priority-based folding operation is being performed for the set of block stripes in the immediate folding queue.

At operation 414, the processing logic initiates deadline-based folding for the set of block stripes in the immediate folding queue. The processing logic may initiate a deadline-based folding operation for the set of block stripes in the immediate folding queue based on determining that a priority-based folding operation is not being performed for the set of block stripes in the immediate folding queue. In one example, the processing logic may determine, at a first time that is in accordance with the pacing value (for example, at a first instance of a ten minute time interval), that a priority-based folding operation is not being performed for the set of block stripes in the immediate folding queue Therefore, the processing logic may initiate a deadline-based folding operation for the set of block stripes in the immediate folding queue at a time that corresponds to the first instance of the pacing value. In another example, the processing logic may determine, at the first time that is in accordance with the pacing value (for example, at the first instance of the ten minute time interval), that a priority-based folding operation is being performed for the set of block stripes in the immediate folding queue. Therefore, the processing logic may refrain from initiating a deadline-based folding operation for the set of block stripes in the immediate folding queue at the time that corresponds to the first instance of the pacing value. However, the processing logic may determine, at a second time that is in accordance with the pacing value (for example, at a second instance of the ten minute time interval), that a priority-based folding operation is not being performed for the set of block stripes in the immediate folding queue. Therefore, the processing logic may initiate the deadline-based folding operation for the set of block stripes in the immediate folding queue at the time that corresponds to the second instance of the pacing value.

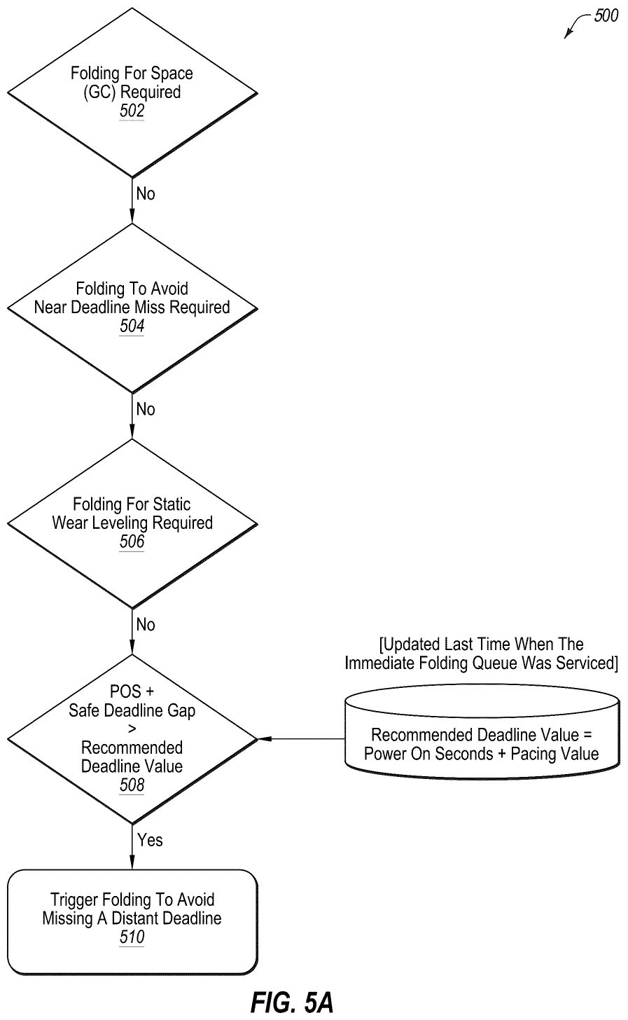

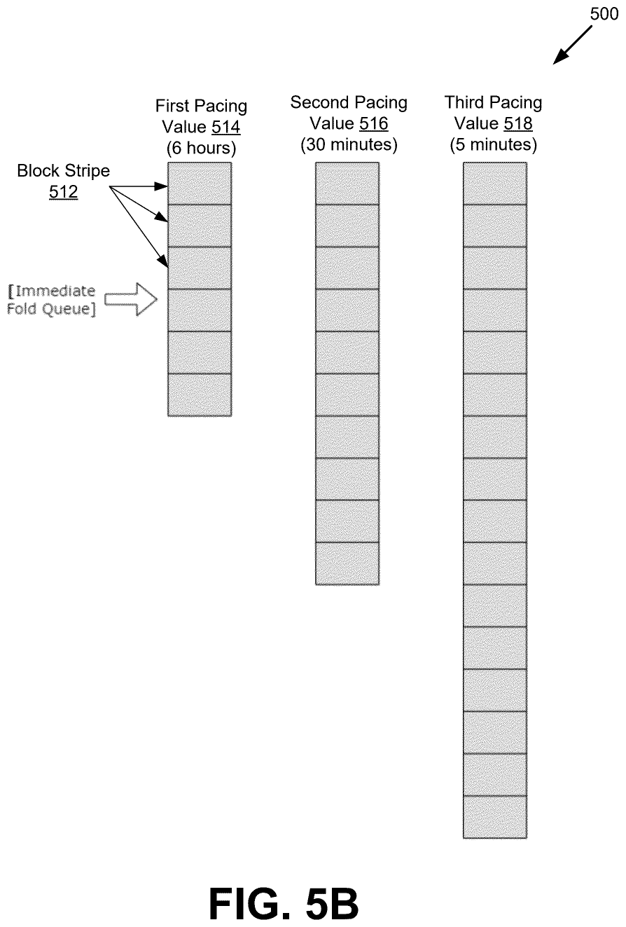

FIGS. 5A-5B are sequence diagrams of an example method 500 of performing block stripe management using deadline-based folding, in accordance with some aspects of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some aspects, one or more operations of the method 500 are performed by the data folding component 113 of FIG. 1. Although shown in a particular sequence or order, unless otherwise specified, the order of the processes can be modified. Thus, the illustrated aspects should be understood only as examples, and the illustrated processes can be performed in a different order, and some processes can be performed in parallel. Additionally, one or more processes can be omitted in various aspects. Thus, not all processes are required in every aspect. Other process flows are possible.

As shown in FIG. 5A and at operation 502, the processing logic determines whether folding for space is required. For example, the processing logic may determine whether a garbage collection operation is required for a set of block stripes in an immediate folding queue. If folding for space is required, the processing logic may initiate a garbage collection operation for the set of block stripes. If folding for space is not required, the processing logic may proceed to operation 504.

At operation 504, the processing logic determines whether folding to avoid a near deadline miss is required. For example, the processing logic may determine whether one or more block stripes in the set of block stripes has a deadline that is within a threshold time of a current time value of the memory device. If the folding to avoid the near deadline miss is required, the processing logic may initiate a folding operation for the set of block stripes. If the folding to avoid the near deadline miss is not required, the processing logic may proceed to operation 506.

At operation 506, the processing logic determines whether folding for static wear leveling is required. For example, the processing logic may determine whether a program/erase cycle of one or more block stripes in the set of block stripes is higher than a program/erase cycle count of one or more other block stripes in the set of block stripes. If the folding for the static wear leveling is required, the processing logic may initiate a folding operation for the set of block stripes. If the folding for the static wear leveling is not required, the processing logic may proceed to operation 508.

At operation 508, the processing logic determines whether a sum of a power-on-seconds (POS) of the memory device and a safe deadline gap is greater than a recommended deadline value. The POS of the memory device may indicate a time (in seconds) since the memory device has been activated (or a most recent time at which the memory device has been activated). The safe deadline gap may be a threshold time period between the POS of the memory device and the recommended deadline value. The recommended deadline value may be a recommended time at which an immediate folding operation is to be performed for a block stripe. In some aspects, the recommended deadline value may be updated each time that the immediate folding queue is serviced. In this example, the recommended deadline value may be equal to a sum of the POS at last time that the immediate folding queue was serviced and the pacing value for the immediate folding queue. If the sum of the POS and the safe deadline gap is less than or equal to the recommended deadline value, the processing logic may not initiate immediate folding for the set of block stripes in the immediate folding queue.

At operation 510, if the sum of the POS and the safe deadline gap is greater than the recommended deadline value, the processing logic may initiate immediate folding for the set of block stripes in the immediate folding queue.

As shown in FIG. 5B, the immediate folding queue may include a plurality of block stripes 512. The processing logic may perform immediate folding for the block stripes 512 in the immediate folding queue using a pacing value. As described herein, the pacing value may be based on the quantity of block stripes (BS) in the immediate folding queue. An example of the PVTC of the immediate folding queue and the corresponding pacing values is shown in Table 1.

TABLE 1

| PVTC of Immediate Folding Queue | Pacing Value | |
|---|---|---|
| >1000 BS | 15 | seconds |
| >500 BS and ≤1000 BS | 30 | seconds |
| >180 BS and ≤500 BS | 5 | minutes |
| >20 BS and ≤180 BS | 30 | minutes |
| ≤20 BS | 6 | hours |

As shown in the example Table 1, the processing logic may use a pacing value having a shorter duration based on a larger number of block stripes being included in the PVTC of the immediate folding queue and may use a pacing value having a longer duration based on a smaller number of block stripes being included in the PVTC of the immediate folding queue. For example, the processing logic may use a first pacing value 514 (six hours) based on a smaller number of block stripes being included in the PVTC of the immediate folding queue, a second pacing value 516 (30 minutes) based on a medium number of block stripes being included in the PVTC of the immediate folding queue, or a third pacing value 518 (5 minutes) based on a larger number of block stripes being included in the PVTC of the immediate folding queue. As described herein, the pacing value may correspond to a rate at which the processing logic performs data folding operations for a set of block stripes in the immediate folding queue. For example, the processing logic may perform operations 502 through 510 described above using a duration that is in accordance with the pacing value. This may increase a likelihood of satisfying immediate folding deadlines while reducing write amplification on the memory device.

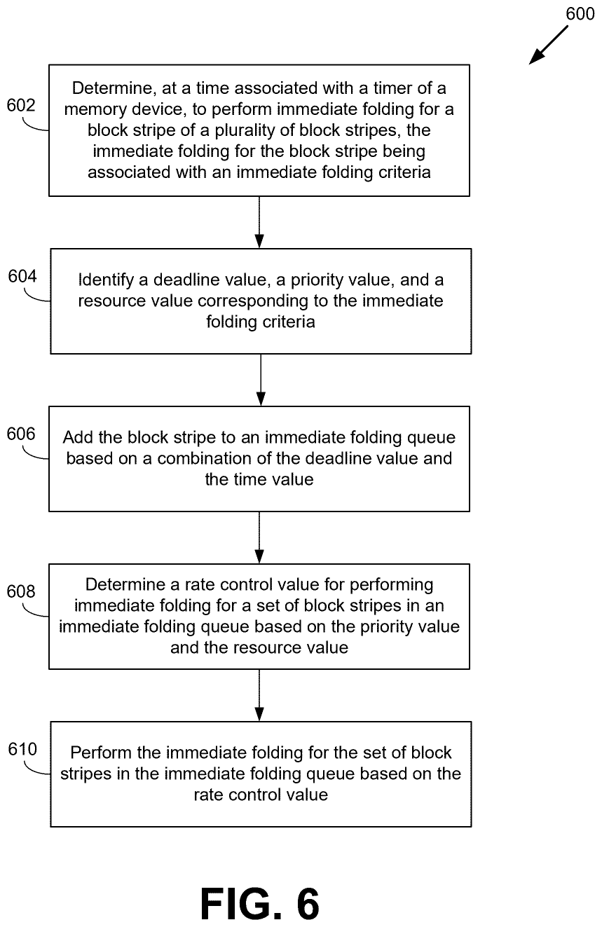

FIG. 6 is a flow diagram of an example method 600 of performing block stripe management using rate control, in accordance with some aspects of the present disclosure. The method 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some aspects, the method 600 is performed by the data folding component 113 of FIG. 1. Although shown in a particular sequence or order, unless otherwise specified, the order of the processes can be modified. Thus, the illustrated aspects should be understood only as examples, and the illustrated processes can be performed in a different order, and some processes can be performed in parallel. Additionally, one or more processes can be omitted in various aspects. Thus, not all processes are required in every aspect. Other process flows are possible.

At operation 602, the processing logic determines, at a time value associated with a timer of the memory device, to perform immediate folding for a block stripe of a plurality of block stripes, where each block stripe of the plurality of block stripes spans the plurality of dies of the memory device, and the immediate folding for the block stripe is associated with an immediate folding criteria. At operation 604, the processing logic identifies a deadline value, a priority value, and a resource value corresponding to the immediate folding criteria. At operation 606, the processing logic adds the block stripe to an immediate folding queue based on a combination of the deadline value and the time value, where the immediate folding queue includes a set of block stripes that are to be folded by the processing device. At operation 608, the processing logic determines, based on the priority value and the resource value, a rate control value for performing immediate folding for the set of block stripes in the immediate folding queue. At operation 610, the processing logic performs the immediate folding for the set of block stripes in the immediate folding queue using the rate control value.

In some implementations, the immediate folding criteria corresponds to an occurrence of a programming fail, a logical unit number fail, a read disturb scan, a background scan, a retention scan, a secure erase, or a detection of an uncorrectable read error.

In some implementations, the deadline value indicates a maximum time period for completing the immediate folding, the priority value indicates a priority for the immediate folding for the block stripe that is based on the immediate folding criteria, and the resource value indicates at least one of quantity of processing resources or a percentage of processing resources to be used for performing the immediate folding.

In some implementations, the immediate folding queue indicates a block stripe identifier, a combined deadline value, a priority value, and a resource value for each block stripe in the set of block stripes in the immediate folding queue, where the combined deadline value is a sum of the time value and the deadline value corresponding to the immediate folding criteria, and the set of block stripes are sorted in the immediate folding queue based on the combined deadline value.

In some implementations, the plurality of block stripes are organized in a written queue that indicates a block stripe identifier, a version number, and a physical valid translation unit count for each block stripe of the plurality of block stripes, where the plurality of block stripes are sorted in the written queue based on the version number. In some implementations, to determine to perform the immediate folding for the block stripe, the processing logic selects the block stripe from the written queue based on the block stripe having a lowest physical valid translation unit count of the plurality of block stripes in the written queue.

In some implementations, the rate control value indicates whether the processing device is to prioritize a first type of folding operation over a second type of folding operation. In some implementations, the first type of folding operation is a data-to-data folding operation and the second type of folding operation is a cache-to-data folding operation.

In some implementations, the processing logic determines a system priority value that corresponds to a highest priority value of the plurality of block stripes in the immediate folding queue, determines a physical value translation unit count value that corresponds to a total physical value translation unit count of the set of block stripes in the immediate folding queue, and selects an immediate folding ratio impact value based on the system priority value and the physical value translation unit count value. In some implementations, to determine the rate control value for performing the immediate folding for the set of block stripes in the immediate folding queue, the processing logic calculates the rate control value based on a combination of the immediate folding ratio impact value and the resource value. In some implementations, the resource value is one of a first resource value indicating that all immediate folding processing resources are to be used for performing the immediate folding or a second resource value indicating that a portion of the immediate folding processing resources are to be used for performing the immediate folding.

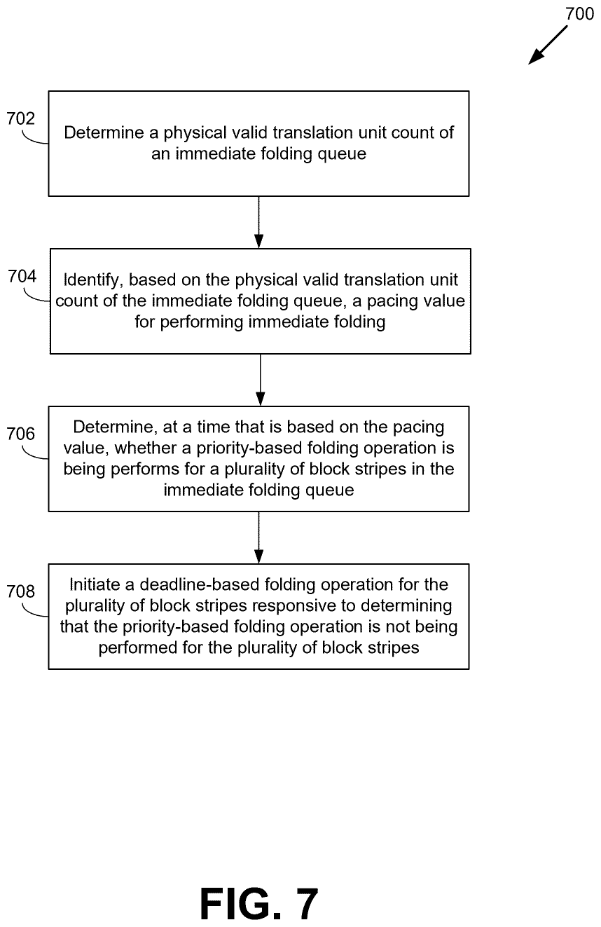

FIG. 7 is a flow diagram of an example method 700 of performing block stripe management using deadline-based folding, in accordance with some aspects of the present disclosure. The method 700 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some aspects, the method 700 is performed by the data folding component 113 of FIG. 1. Although shown in a particular sequence or order, unless otherwise specified, the order of the processes can be modified. Thus, the illustrated aspects should be understood only as examples, and the illustrated processes can be performed in a different order, and some processes can be performed in parallel. Additionally, one or more processes can be omitted in various aspects. Thus, not all processes are required in every aspect. Other process flows are possible.

At operation 702, the processing logic determines a physical valid translation unit count of an immediate folding queue, where the immediate folding queue includes a plurality of block stripes for which immediate folding is to be performed, and where each block stripe of the plurality of block stripes spans the plurality of dies of the memory device. At operation 704, the processing logic identifies, based on the physical valid translation unit count of the immediate folding queue, a pacing value for performing the immediate folding. At operation 706, the processing logic determines, at a time that is based on the pacing value, whether a priority-based folding operation is being performed for the plurality of block stripes. At operation 708, the processing logic initiates a deadline-based folding operation for the plurality of block stripes responsive to determining that the priority-based folding operation is not being performed for the plurality of block stripes.

In some implementations, the pacing value indicates a time interval at which the processing device is to determine whether the priority-based folding operation is being performed, and the time that is based on the pacing value is a time that is in accordance with the time interval.

In some implementations, the physical valid translation unit count of the immediate folding queue indicates a total quantity of physical valid translation units of all block stripes included in the immediate folding queue. In some implementations, to identify the pacing value that is based on the physical valid translation unit count of the immediate folding queue, the processing logic accesses a look-up table that includes a plurality of physical valid translation unit count values and a plurality of corresponding pacing values, and selects the pacing value using a physical valid translation unit count value of the plurality of physical valid translation unit count values that corresponds to the physical valid translation unit count of the immediate folding queue.

In some implementations, the priority-based folding operation includes a folding operation associated with increasing available space on the memory device, a folding operation associated with satisfying a priority value, or a folding operation associated with performing static wear leveling.

In some implementations, a deadline associated with the deadline-based folding operation is based on a sum of the pacing value and a power-on-time of the memory device. In some implementations, the processing logic updates the deadline for the deadline-based folding operation based on a priority-based folding or a deadline-based folding being performed for one or more block stripes of the plurality of block stripes included in the immediate folding queue. In some implementations, to initiate the deadline-based folding operation, the processing logic initiates the deadline-based folding operation based on a sum the power-on-time of the memory device and a buffer time value satisfying a deadline threshold value. In some implementations, to perform the deadline-based folding operation for the plurality of block stripes, the processing logic alternates between deadline-based folding operations and priority-based folding operations in accordance with the deadline.

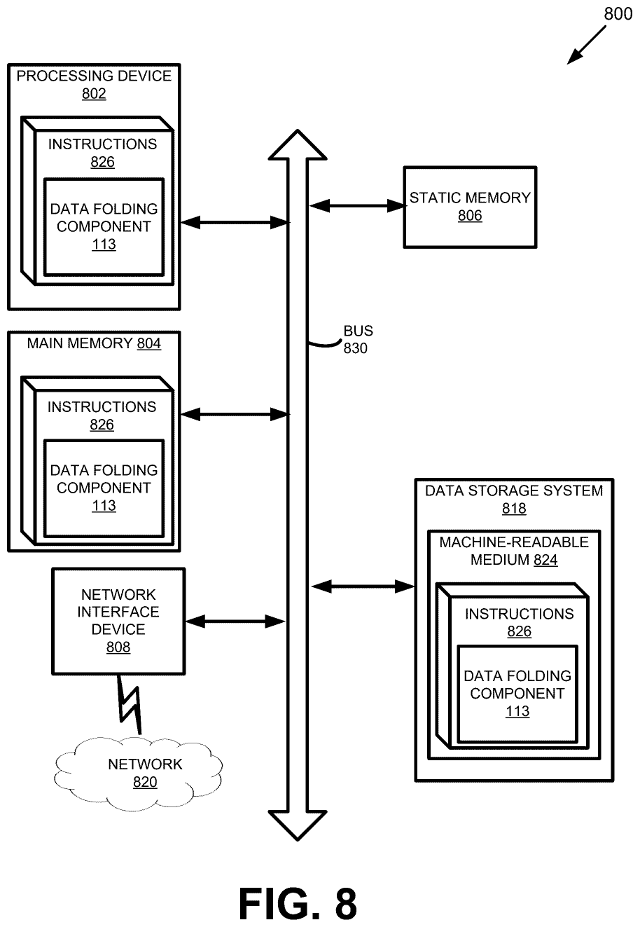

FIG. 8 illustrates an example machine of a computer system 800 within which a set of instructions, for causing the machine to perform any one or more of the methodologies discussed herein, can be executed. In some aspects, the computer system 800 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the block stripe allocation component 113 of FIG. 1). In alternative aspects, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 800 includes a processing device 802, a main memory 804 (e.g., read-only memory (ROM), flash memory, dynamic random access memory (DRAM) such as synchronous DRAM (SDRAM) or Rambus DRAM (RDRAM), etc.), a static memory 806 (e.g., flash memory, static random access memory (SRAM), etc.), and a data storage system 818, which communicate with each other via a bus 830.

Processing device 802 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 802 can also be one or more special-purpose processing devices such as an application specific integrated circuit (ASIC), a field programmable gate array (FPGA), a digital signal processor (DSP), network processor, or the like. The processing device 802 is configured to execute instructions 826 for performing the operations and steps discussed herein. The computer system 800 can further include a network interface device 808 to communicate over the network 820.

The data storage system 818 can include a machine-readable storage medium 824 (also known as a computer-readable medium) on which is stored one or more sets of instructions 826 or software embodying any one or more of the methodologies or functions described herein. The instructions 826 can also reside, completely or at least partially, within the main memory 804 and/or within the processing device 802 during execution thereof by the computer system 800, the main memory 804 and the processing device 802 also constituting machine-readable storage media. The machine-readable storage medium 824, data storage system 818, and/or main memory 804 can correspond to the memory sub-system 110 of FIG. 1.

In some aspects, the instructions 826 include instructions to implement functionality corresponding to the sequential write component 113 of FIG. 1). While the machine-readable storage medium 824 is shown in an example aspect to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some aspects, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, aspects of the disclosure have been described with reference to specific example aspects thereof. It will be evident that various modifications can be made thereto without departing from the broader spirit and scope of aspects of the disclosure as set forth in the following claims. The specification and drawings are, accordingly, to be regarded in an illustrative sense rather than a restrictive sense.

What is claimed is:

1. A system comprising:
a memory device comprising a plurality of dies; and
a processing device, coupled with the memory device, configured to perform operations comprising:
determining a physical valid translation unit count of an immediate folding queue, wherein the immediate folding queue includes a plurality of block stripes for which immediate folding is to be performed, and wherein each block stripe of the plurality of block stripes spans the plurality of dies of the memory device;
identifying, based on the physical valid translation unit count of the immediate folding queue, a pacing value for performing the immediate folding;
determining, at a time that is based on the pacing value, whether a priority-based folding operation is being performed for the plurality of block stripes; and
initiating a deadline-based folding operation for the plurality of block stripes responsive to determining that the priority-based folding operation is not being performed for the plurality of block stripes.

2. The system of claim 1, wherein the pacing value indicates a time interval at which the processing device is to determine whether the priority-based folding operation is being performed, and wherein the time that is based on the pacing value is a time that is in accordance with the time interval.

3. The system of claim 1, wherein the physical valid translation unit count of the immediate folding queue indicates a total quantity of physical valid translation units of all block stripes included in the immediate folding queue.

4. The system of claim 3, wherein the processing device, to identify the pacing value that is based on the physical valid translation unit count of the immediate folding queue, is configured to perform operations comprising:
accessing a look-up table that includes a plurality of physical valid translation unit count values and a plurality of corresponding pacing values; and
selecting the pacing value using a physical valid translation unit count value of the plurality of physical valid translation unit count values that corresponds to the physical valid translation unit count of the immediate folding queue.

5. The system of claim 1, wherein the priority-based folding operation includes a folding operation associated with increasing available space on the memory device, a folding operation associated with satisfying a priority value, or a folding operation associated with performing static wear leveling.

6. The system of claim 1, wherein a deadline associated with the deadline-based folding operation is based on a sum of the pacing value and a power-on-time of the memory device.

7. The system of claim 6, wherein the processing device is configured to perform operations comprising updating the deadline for the deadline-based folding operation based on a priority-based folding or a deadline-based folding being performed for one or more block stripes of the plurality of block stripes included in the immediate folding queue.

8. The system of claim 6, wherein the processing device, to initiate the deadline-based folding operation, is configured to initiate the deadline-based folding operation based on a sum the power-on-time of the memory device and a buffer time value satisfying a deadline threshold value.

9. The system of claim 6, wherein the processing device, to perform the deadline-based folding operation for the plurality of block stripes, is configured to alternate between deadline-based folding operations and priority-based folding operations in accordance with the deadline.

10. A method comprising:
determining a physical valid translation unit count of an immediate folding queue, wherein the immediate folding queue includes a plurality of block stripes for which immediate folding is to be performed, and wherein each block stripe of the plurality of block stripes spans the plurality of dies of a memory device;
identifying, based on the physical valid translation unit count of the immediate folding queue, a pacing value for performing the immediate folding;
determining, at a time that is based on the pacing value, whether a priority-based folding operation is being performed for the plurality of block stripes; and
initiating a deadline-based folding operation for the plurality of block stripes responsive to determining that the priority-based folding operation is not being performed for the plurality of block stripes.

11. The method of claim 10, wherein the pacing value indicates a time interval at which a processing device is to determine whether the priority-based folding operation is being performed, and wherein the time that is based on the pacing value is a time that is in accordance with the time interval.

12. The method of claim 10, wherein the physical valid translation unit count of the immediate folding queue indicates a total quantity of physical valid translation units of all block stripes included in the immediate folding queue.

13. The method of claim 10, wherein the priority-based folding operation includes a folding operation associated with increasing available space on the memory device, a folding operation associated with satisfying a priority value, or a folding operation associated with performing static wear leveling.

14. The method of claim 10, wherein a deadline associated with the deadline-based folding operation is based on a sum of the pacing value and a power-on-time of the memory device.

15. The method of claim 14, further comprising updating the deadline for the deadline-based folding operation based on a priority-based folding or a deadline-based folding being performed for one or more block stripes of the plurality of block stripes included in the immediate folding queue.

16. The method of claim 14, wherein initiating the deadline-based folding operation comprises initiating the deadline-based folding operation based on a sum the power-on-time of the memory device and a buffer time value satisfying a deadline threshold value.

17. The method of claim 14, wherein performing the deadline-based folding operation for the plurality of block stripes comprises alternating between deadline-based folding operations and priority-based folding operations in accordance with the deadline.

18. A non-transitory computer-readable storage medium comprising instructions that, when executed by a processing device, cause the processing device to perform operations comprising:
determining a physical valid translation unit count of an immediate folding queue, wherein the immediate folding queue includes a plurality of block stripes for which immediate folding is to be performed, and wherein each block stripe of the plurality of block stripes spans the plurality of dies of a memory device;
identifying, based on the physical valid translation unit count of the immediate folding queue, a pacing value for performing the immediate folding;
determining, at a time that is based on the pacing value, whether a priority-based folding operation is being performed for the plurality of block stripes; and
initiating a deadline-based folding operation for the plurality of block stripes responsive to determining that the priority-based folding operation is not being performed for the plurality of block stripes.

19. The non-transitory computer-readable storage medium of claim 18, wherein the pacing value indicates a time interval at which the processing device is to determine whether the priority-based folding operation is being performed, and wherein the time that is based on the pacing value is a time that is in accordance with the time interval.

20. The non-transitory computer-readable storage medium of claim 18, wherein the physical valid translation unit count of the immediate folding queue indicates a total quantity of physical valid translation units of all block stripes included in the immediate folding queue.
